(19) United States
(12) Patent Application Publication
(10) Pub. No.: US 2005/0128382 A1
(43) Pub. Date: Jun. 16, 2005

(54) Color filter substrate, fabrication method thereof and liquid crystal display panel having the same

(76) Inventors: Dong-Ki Baek, Gumi (KR); Seung-Won Moon, Seo-Gu (KR)

Correspondence Address: MCKENNA LONG & ALDRIDGE LLP, 1900 K STREET, NW, WASHINGTON, DC, 20006, US

(21) Appl. No.: 11/004,925

(22) Filed: Dec. 7, 2004

(30) Foreign Application Priority Data
Dec. 11, 2003 (KR) 2003-90284

(51) Int. Cl. G02F 1/1335

(52) U.S. Cl. 349/106

(57) ABSTRACT

A color filter substrate, a method thereof and a liquid crystal display panel having the same are disclosed. The color filter substrate includes: red, green and blue color filters corresponding to a pixel region and arranged to be predeterminedly separated; a black matrix formed on a region where the red, green and blue color filters are separated in a horizontal direction and in a vertical direction; and column spacers on horizontal and vertical intersections of the black matrix. Rubbing defects are prevented on the pixel region by forming the column spacers on all the horizontal and vertical intersections or on some of the horizontal and vertical intersections of the black matrix. Thus, defect factors of the liquid crystal display device can be minimized.

This application claims the benefit of Korean Patent Application No. 90284/2003, filed on Dec. 11, 2003, which is hereby incorporated by reference for all purposes as if fully set forth herein.

### BACKGROUND OF THE INVENTION

1. Field of the Invention

The present invention relates to a color filter substrate, a fabricating method thereof and a liquid crystal display panel having the same. More particularly, the present invention relates to a color filter substrate, a fabricating method thereof and a liquid crystal display panel capable of preventing defects in alignment of liquid crystal molecules from occurring due to column spacers on a pixel region of a first mother substrate and a second mother substrate which are bonded to maintain a uniform cell-gap by the column spacers.

2. Discussion of the Related Art

A liquid crystal display device displays desired images by individually providing data signals to pixels arranged in a matrix form according to image information to thereby control the light transmittance of the pixels.

Accordingly, the liquid crystal display device is provided with a liquid crystal display panel on which pixels are arranged in a matrix form and a driving circuit for driving the pixels.

The liquid crystal display panel includes a thin film transistor array substrate and a color filter substrate which face each other and are bonded together to maintain a uniform cell-gap, and a liquid crystal layer formed at an interval between the color filter substrate and the thin film transistor array substrate.

In addition, the thin film transistor array substrate and the color filter substrate are bonded by a seal pattern formed at an outer edge of an effective image display unit. A spacer is formed on the thin film transistor array substrate or the color filter substrate, and maintains a uniform cell-gap of the bonded thin film transistor array substrate and color filter substrate.

A polarizing plate and a phase retardation plate may be provided to outer surfaces of the thin film transistor array substrate and the color filter substrate. Including components like the polarizing plate and phase retardation plate, a liquid crystal display panel which has high brightness and contrast characteristics is constructed by changing a state that light proceeds or the index of refraction.

A common electrode and a pixel electrode are formed on the liquid crystal display panel in which the thin transistor array substrate and the color filter substrate face each other and are bonded. The common electrode and the pixel electrode apply the electric field to the liquid crystal layer. That is, by controlling a voltage applied to the pixel electrode in a state that the voltage is applied to the common electrode, the light transmittance of unit pixels can be individually controlled. To control the voltage applied to the pixel electrode according to each unit pixel, a thin film transistor may be used as a switching device for each unit pixel.

An alignment layer is formed on a surface where the thin film transistor array substrate and the color filter substrate face each other, and rubbing is performed to arrange liquid crystal of the liquid crystal layer in a certain direction.

The liquid crystal display device is generally classified as a twisted nematic (TN) mode liquid crystal display panel and an in-plane switching (IPS) mode liquid crystal display panel.

In the TN mode liquid crystal display panel, the pixel electrode is formed on the thin film transistor array substrate according to each unit pixel, and the common electrode is formed on an entire surface of the color filter substrate.

Accordingly, the liquid crystal layer is driven by the electric field formed between the pixel electrode formed on the thin film transistor array substrate and the common electrode formed on the color filter substrate.

In the IPS mode liquid crystal display panel, the pixel electrode and the common electrode are predeterminedly separated from the thin film transistor array substrate. Therefore, the liquid crystal layer is driven by the lateral electric field between the pixel electrode formed on the thin film transistor array substrate and the common electrode.

Here, red, green and blue color filters are predeterminedly separated to correspond to a pixel region and are arranged in a matrix form. A black matrix is formed in a net shape on a region where the red, green and blue color filters are separated.

Column spacers arranged together with the red color filters, the green color filters and the blue color filters are formed on the black matrix in which the red color filters, the green color filters and the blue color filters are disposed adjacent to each other in a vertical direction. The column spacers allow a uniform cell-gap to be maintained when bonding the color filter substrate and the thin film transistor array substrate.

An alignment layer (not shown) is formed on the surface of the color filter substrate having the red, green and blue color filters, the black matrix and the column spacers, and then rubbing is performed. At this time, in the rubbing process, a polymer chain on a surface of the alignment layer is aligned in a certain direction by rubbing the surface of the alignment layer with a rubbing cloth under a uniform pressure and at a uniform rate.

Accordingly, when forming a liquid crystal layer at the cell-gap after bonding the color filter substrate and the thin film transistor array substrate by the column spacers to maintain uniform the cell-gap, liquid crystal molecules are arranged in a certain direction by the alignment layer.

As described, the column spacers are formed on a region where the red color filters, the green color filters and the blue color filters are disposed adjacent to each other in the vertical direction of the black matrix. Therefore, when rubbing the alignment layer, rubbing defects occur on the pixel region along the rubbing direction.

That is, in the case that the column spacers are formed on the region where the red color filters, the green color filters and the blue color filters are disposed adjacent to each other in the vertical direction of the black matrix and that rubbing is performed by driving a rubbing roll from top to bottom by rotating the rubbing roll, in which the rubbing cloth is rolled, at a high speed, the rubbing cloth gets damaged by the height of the column spacer. Therefore, the rubbing defects are generated from top to bottom of the pixel region on which the red, green and blue color filters are formed.

The color filter substrate of the related art liquid crystal display panel deteriorates picture quality of the liquid crystal display device since the rubbing defects are generated, and produces defects which decrease the yield.

In particular, since the liquid crystal display device is mass-produced, the same rubbing defect is repeatedly generated on the liquid crystal display device of the same model. As a result, there is a problem that picture quality and yield deteriorations of the liquid crystal display device are continuously generated.

### SUMMARY OF THE INVENTION

Accordingly, the present invention is directed to a color filter substrate, fabrication method thereof and liquid crystal display panel having the same that substantially obviates one or more of the problems due to limitations and disadvantages of the related art.

An advantage of the present invention is to provide a color filter substrate, a method thereof and a liquid crystal display panel having the same capable of preventing defects in alignment of liquid crystal molecules from occurring due to column spacers in a pixel region of a first mother substrate and a second mother substrate which are bonded to maintain a uniform cell-gap by the column spacers.

In addition, another advantage of the present invention is to provide a color filter substrate, a method thereof and a liquid crystal display panel having the same capable of preventing continuous generation of picture quality and yield deteriorations of a liquid crystal display device by preventing the same rubbing defect from repeatedly generating in the liquid crystal display device which is mass-produced, with the same model.

To achieve these and other advantages and in accordance with the purpose of the present invention, as embodied and broadly described herein, a color filter substrate comprises red, green and blue color filters corresponding to a pixel region; a black matrix on a region where the red, green and blue color filters are separated in a horizontal direction and in a vertical direction; and column spacers on the horizontal and vertical intersections of the black matrix, and

In another aspect, a method of fabricating a color filter substrate comprises forming a black matrix on a substrate to separate pixel regions of the substrate; forming red, green and blue color filters on the pixel regions of the substrate; forming column spacers on horizontal and vertical intersections of the black matrix; and forming an alignment layer on a surface of the substrate.

In another aspect, a liquid crystal display panel comprises a plurality of gate and data lines on a first substrate, the gate and data lines crossing each other to define pixel regions; switching devices at the crossing of the gate and data lines; at least one pair of a common electrode and a pixel electrode on the pixel region; a color filter layer on a second substrate, the color filter layer corresponding to the pixel regions; a black matrix layer on a separated region of the color filter layer in horizontal and vertical regions; a column spacer on a crossing portion of horizontal and vertical regions of the black matrix layer; and a liquid crystal layer between the first and second substrates.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an exemplary view showing a plan structure of a color filter substrate of a liquid crystal display panel in accordance with the present invention;

FIG. 2 is an exemplary view showing a sectional structure of the color filter substrate cut along line I-I in FIG. 1;

FIG. 3 is an exemplary view showing rubbing defects are not generated when performing the rubbing on the color filter substrate in FIG. 2;

FIG. 4 is an exemplary view showing a plan structure of a unit pixel of a related art IPS mode liquid crystal display panel; and

FIG. 5 is an exemplary view showing a plan structure of the unit pixel of the IPS mode liquid crystal display panel in which a common electrode and a pixel electrode are arranged in a zigzag pattern.

### DETAILED DESCRIPTION OF THE ILLUSTRATED EMBODIMENTS

Hereinafter, description will now be made in detail to a color filter substrate, a method thereof and a liquid crystal display panel having the same in accordance with the present invention with reference to the accompanying drawings.

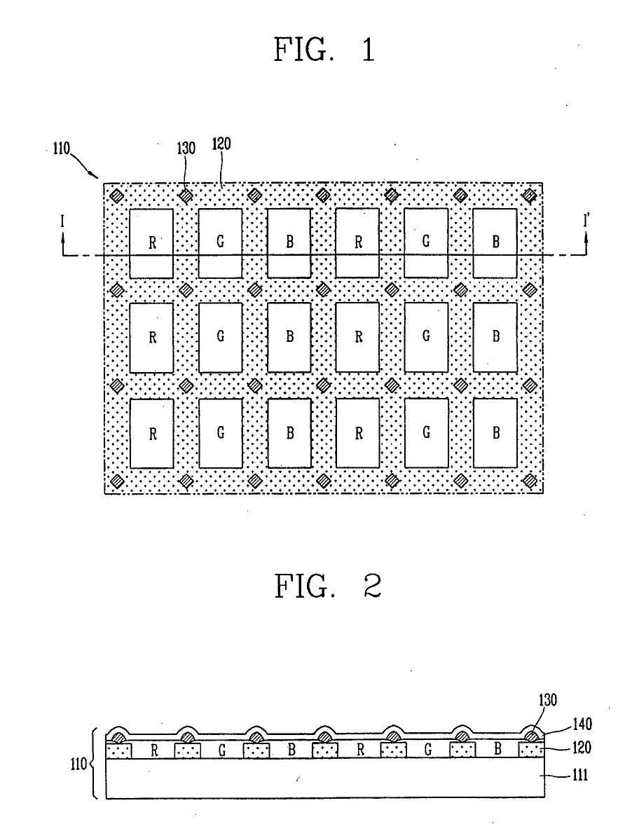

FIG. 1 is an exemplary view showing a plan structure of a color filter substrate of a liquid crystal display panel in accordance with the present invention.

In FIG. 1, red, green and blue color filters (R, G and B) are predeterminedly separated in a vertical direction and in a horizontal direction in order that they can correspond to a pixel region, and are arranged in a matrix form. A black matrix 120 is formed in a net shape on a region where the red, green and blue color filters (R, G and B) are separated vertically and horizontally.

As described, in a case of a TN mode liquid crystal display panel in which a pixel electrode is formed on a thin film transistor array substrate and a common electrode is formed on the color filter substrate 110, the common electrode can be additionally formed on an entire surface of the color filter substrate 110. On the other hand, in a case of an IPS mode liquid crystal display panel in which the pixel electrode and the common electrode are formed on the thin film transistor array substrate, the common electrode is not formed on the color filter substrate 110.

Additionally, an over-coat layer for planarization of the surface may be formed on an entire surface of the color filter substrate 110 on which the red, green and blue color filters (R, G and B) and the black matrix 120 are formed.

Column spacers may be formed on horizontal and vertical intersections of the net-shaped black matrix 120. When bonding the color filter substrate 110 and the above-described thin film transistor array substrate, the column spacers allow a uniform cell-gap to be maintained. The column spacers 130 can be formed on all the horizontal and vertical intersections of the net-shaped black matrix 120, or can be formed on some of the horizontal and vertical intersections of the net-shaped black matrix 120.

An alignment layer (not shown) having polyimide material is formed on the surface of the color filter substrate 110 having the red, green and blue color filters (R, G and B), the black matrix 120 and the column spacers 130. Then, an alignment process is performed. In the alignment process, a polymer chain on a surface of the alignment layer is arranged in a certain direction by rubbing the surface of the alignment layer with a cloth under a uniform pressure and at a uniform rate.

Accordingly, after bonding the color filter substrate 110 and the thin film transistor array substrate using the column spacers 130 to maintain a uniform cell-gap, when forming a liquid crystal layer on the cell-gap, liquid crystal molecules are arranged by the alignment layer in a certain direction.

A fabrication method of a color filter substrate of a liquid crystal display panel in accordance with the present invention will be described with reference to the accompanying drawings.

FIG. 2 is an exemplary view showing a sectional structure of the color filter substrate 110 along line I-I in FIG. 1.

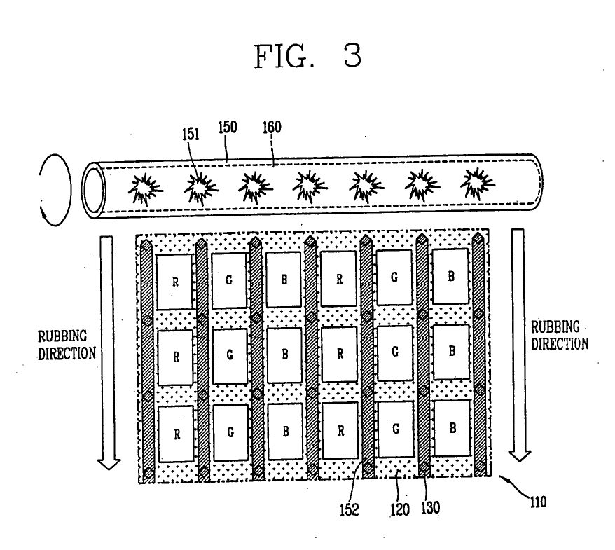

FIG. 3 is an exemplary view showing rubbing defects are not generated when performing the rubbing on the color filter substrate in FIG. 2.

With reference to FIG. 2, the black matrix 120 is predeterminedly separated on a glass substrate 111. At this time, the black matrix 120 is formed in a net shape in order that the black matrix can separate pixel regions on the glass substrate 111.

Thereafter, red, green and blue color filters (R, G and B) filters are formed on a region where the black matrix 120 is separated. The red, green and blue color filters (R, G and B) are predeterminedly separated in the vertical direction and in the horizontal direction so as to correspond to the pixel region on the glass substrate 111, and therefore they are arranged in a matrix form.

In a case of a TN mode liquid crystal display panel in which a pixel electrode is formed on a thin film transistor array substrate and a common electrode is formed on the color filter substrate 110, the common electrode can be additionally formed on a surface of the glass substrate 111 on which the black matrix 120 and the red, green and blue color filters (R, G and B) are formed. On the other hand, in a case of an IPS mode liquid crystal display panel in which the pixel electrode and the common electrode are formed on the thin film transistor array substrate, the common electrode is not formed on the glass substrate 111.

Additionally, an overcoat layer for planarization of the surface may be formed on an entire surface of the color filter substrate 110 on which the red, green and blue color filters (R, G and B) and the black matrix 120 are formed.

Subsequently, column spacers 130 which are aligned on the black matrix 120 are formed. At this time, as shown in FIG. 1, the column spacers 130 may be formed on the horizontal and vertical intersections of the net-shaped black matrix 120. The column spacers 130 may be formed on all the horizontal and vertical intersections of the net-shaped black matrix 120. Or, the column spacers may be formed on some of the horizontal and vertical intersections of the net-shaped black matrix 120.

Thereafter, an alignment layer 140 having polyimide material is formed on the surface of the glass substrate 111 having the black matrix 120, the red, green and blue color filters (R, G and B) and the column spacers 130, and then an alignment process is performed from top to bottom as shown in FIG. 1 or from bottom to top. At this time, in the alignment process, a polymer chain on a surface of the alignment layer 140 is arranged in a certain direction by rubbing the surface of the alignment layer 140 with a cloth under a uniform pressure and at a uniform rate.

Accordingly, when forming a liquid crystal layer on the cell-gap after bonding the color filter substrate and the thin film transistor array substrate by the column spacers to maintain uniform cell-gap, liquid crystal molecules are arranged by the alignment layer 140 in a certain direction.

As described, in the color filter substrate, the method thereof and the liquid crystal display panel having the same in accordance with the present invention, as the column spacers 130 are formed on all the horizontal and vertical intersections or on some of the horizontal and vertical intersections of the net-shaped black matrix 120, generation of rubbing defects on the pixel region can be prevented when the alignment layer 140 is rubbed from top to bottom as shown in FIG. 1 or from bottom to top.

That is, as shown in FIG. 3, in a case in which the column spacers 130 are formed on the horizontal and vertical intersections of the net-shaped black matrix 120 and that rubbing is performed by driving a rubbing roll 160 from top to bottom as shown in the drawing by rotating the rubbing roll 160 in which a rubbing cloth 150 is rolled, the rubbing cloth 150 may be damaged 151 due to the height of the column spacer 130. In spite of the damage, since rubbing defects 152 are generated along the black matrix 130 from top to bottom as shown in the drawing, the pixel region on which the red, green and blue color filters (R, G and B) are formed is not affected.

Meanwhile, as shown in FIG. 3, the IPS mode liquid crystal display panel can be used as the liquid crystal display panel in which rubbing is performed from top to bottom or from bottom to top.

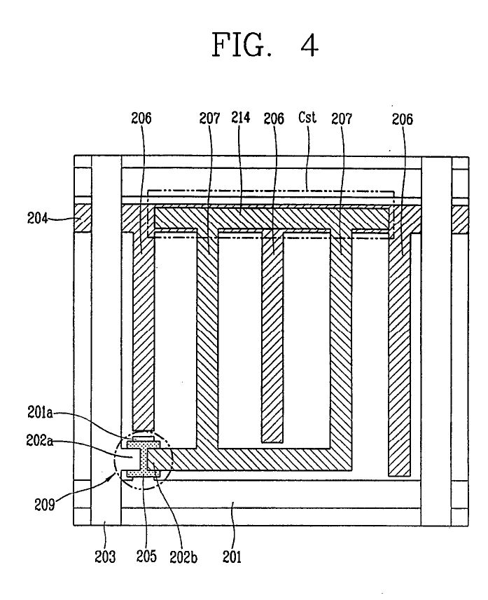

FIG. 4 is an exemplary view showing a plan structure of a unit pixel of a IPS mode liquid crystal display panel.

With reference to FIG. 4, in the IPS mode liquid crystal display device, gate lines 201 and data lines 203 are disposed vertically and horizontally, respectively, to thereby define pixel regions. In a practical liquid crystal panel, the ‘N’ number of gate lines 201 and the ‘M’ number of data lines 203 cross each other to thereby define the ‘N×M’ number of pixel regions.

Here, a thin film transistor 209 made up of a gate electrode 201A, a semiconductor layer 205, a source electrode 202A and a drain electrode 202B are disposed in a region where the gate lines 201 and the data lines 203 cross each other. The gate electrode 201A is connected to the gate line 201, and the source electrode 202A is connected to the data lines 203.

In addition, common lines 204 are disposed parallel to the gate lines 201, and at least a pair of a common electrode 206 and a pixel electrode 207 for applying the electric field to liquid crystal molecules are arranged parallel to the data lines 203.

And, the common electrode 206 is formed simultaneously with the gate lines 201 and connected to the common line 204. The pixel electrode 207 is formed simultaneously with the source and drain electrodes 202A and 202B and connected to the drain electrode 202B of the thin film transistor 209.

In addition, a pixel electrode line 214 connected to the pixel electrode 207 overlaps with the common line 204 and an insulating layer to thereby form a storage capacitor (Cst).

An alignment layer is formed on a surface of a thin film transistor array substrate 210 of the IPS mode liquid crystal display panel having such construction, and rubbing is carried out in a direction opposite to the rubbing direction of the color filter substrate 110 of FIG. 3.

The color filter substrate 110 and the thin film transistor array substrate 210 in which rubbing has respectively been performed are bonded, in which the red, green and blue color filters (R, G and B) of the color filter substrate 110 are aligned to correspond to the pixel region of the thin film transistor array substrate 210.

Accordingly, the black matrix 120 formed on the color filter substrate 110 is aligned with the gate lines 201, the data lines 203 and the thin film transistor 209 of the thin film transistor array substrate 210. And, the column spacers 130 are formed on the horizontal and vertical intersections of the black matrix 120, that is, on a region where the gate lines 201 and the data lines 203 cross each other so as to maintain the uniform cell-gap when bonding the color filter substrate 110 and the thin film transistor array substrate 210.

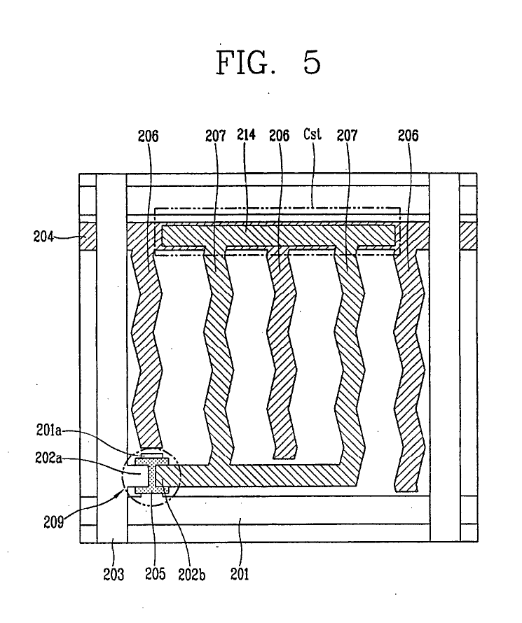

Meanwhile, FIG. 5 is an exemplary view showing a plan structure of the unit pixel of the IPS mode liquid crystal display panel in which the common electrode 206 and the pixel electrode 207 are arranged in a zigzag pattern.

With reference to FIG. 5, the unit pixel of the IPS mode liquid crystal display panel is substantially identical to that of the IPS mode liquid crystal display panel shown in FIG. 4 except for the arrangement of the common electrode 206 and the pixel electrode 207 is a zigzag pattern.

When the common electrode 206 and the pixel electrode 207 are disposed in the zigzag pattern, a multi-domain can be induced because liquid crystal molecules can be arranged in different directions. In such a multi-domain structure, the abnormal light generated in each of domains due to birefringence characteristics of liquid crystals can be offset by each other so that a color shift phenomenon can be minimized.

In the present invention, by forming the column spacers on all the horizontal and vertical intersections or on some of the horizontal and vertical intersections of the net-shaped black, when rubbing is performed from top to bottom as shown in FIG. 3 or from bottom to top, rubbing defects can be prevented from occurring on the pixel region.

The color filter substrate, the method thereof and the liquid crystal display panel having the same in accordance with the present invention in which the column spacers are formed on all the horizontal and vertical intersections or on some of the horizontal and vertical intersections of the net-shaped black matrix can be easily applied to various modes of liquid crystal display panels as well as the IPS mode liquid crystal display panel as shown in FIGS. 4 and 5. Those skilled in the art are able to modify and operate the present invention in fabricating various models of liquid crystal display devices using the concept of the present invention.

As described, in the color filter substrate, the method thereof and the liquid crystal display panel having the same in accordance with the present invention, the column spacers are formed on all the horizontal and vertical intersections or on some of the horizontal and vertical intersections of the net-shaped black matrix. Therefore, when rubbing of the alignment layer is performed from top to bottom or from bottom to top, rubbing defects may be prevented from occurring on the pixel region. Accordingly, deterioration of picture quality of the liquid crystal display device can be prevented and the manufacturing yield may be improved by minimizing defect factors of the liquid crystal display device.

In particular, as the same rubbing defects is prevented from repeatedly generated in liquid crystal display devices mass-produced with the same model, continuous deteriorations of picture quality and manufacturing yield of the liquid crystal display device can be prevented.

It will be apparent to those skilled in the art that various modifications and variation can be made in the present invention without departing from the spirit or scope of the invention. Thus, it is intended that the present invention cover the modifications and variations of the invention provided they come within the scope of the appended claims and their equivalents.

1. A color filter substrate, comprising:
red, green and blue color filters corresponding to a pixel region;
a black matrix on a region where the red, green and blue color filters are separated in a horizontal direction and in a vertical direction; and
column spacers on horizontal and vertical intersections of the black matrix.

2. The color filter substrate of claim 1, further comprising:
an alignment layer formed on upper surfaces of the red, green and blue color filters.

3. The color filter substrate of claim 2, wherein the alignment layer includes polyimide material.

4. The color filter substrate of claim 1, wherein the column spacers are formed on all the horizontal and vertical intersections of the black matrix.

5. The color filter substrate of claim 1, wherein the column spacers are formed at a portion of the horizontal and vertical intersections of the black matrix.

6. The color filter substrate of claim 1, further comprising:
an overcoat layer on upper surfaces of the red, green and blue color filters and the black matrix.

7. A method of fabricating a color filter substrate, comprising:
forming a black matrix on a substrate to separate pixel regions of the substrate;
forming red, green and blue color filters on the pixel regions of the substrate;
forming column spacers on horizontal and vertical intersections of the black matrix; and
forming an alignment layer on a surface of the substrate.

8. The method of claim 7, wherein an alignment process of the alignment layer is performed in one of a top to bottom direction and a bottom to top direction of the black matrix.

9. The method of claim 7, wherein the alignment layer includes polyimide material.

10. The method of claim 7, wherein the column spacers are formed on all portions of the horizontal and vertical intersections of the black matrix.

11. The method of claim 7, wherein the column spacers are formed at a portion of the horizontal and vertical intersections of the black matrix.

12. The method of claim 7, further comprising:
forming an overcoat layer on upper surfaces of the red, green and blue color filters and the black matrix.

13. A liquid crystal display panel, comprising:
a plurality of gate and data lines on a first substrate, the gate and data lines crossing each other to define pixel regions;
switching devices at the crossing of the gate and data lines;
at least one pair of a common electrode and a pixel electrode on the pixel region;
a color filter layer on a second substrate, the color filter layer corresponding to the pixel regions;
a black matrix layer on a separated region of the color filter layer in horizontal and vertical regions;
a column spacer on a crossing portion of horizontal and vertical regions of the black matrix layer; and
a liquid crystal layer between the first and second substrates.

14. The liquid crystal display panel according to claim 13, further comprising first and second alignment layers on the first and second substrates.

15. The liquid crystal display panel of claim 13, wherein the at least one pair of the common electrode and the pixel electrode are arranged in a zigzag pattern.

16. The liquid crystal display panel of claim 13, wherein the column spacers are formed on all portions of the horizontal and vertical intersections of the black matrix.

17. The liquid crystal display panel of claim 13, wherein the column spacers are formed at a portion of the horizontal and vertical intersections of the black matrix.

18. The liquid crystal display panel of claim 13, wherein the color filter layer include red, green and blue color filters.

19. The liquid crystal display panel of claim 18, further comprising: an overcoat layer on upper surfaces of the red, green and blue color filters.
